(19) United States
(12) Patent Application Publication
(10) Pub. No.: US 2021/0347551 A1
(43) Pub. Date: Nov. 11, 2021

(54) Enhanced Antiseptic Wicking Contour-Conforming Beverage Container Wrap Sheet

(71) Applicant: Stephen Nelson, Woodland Hills, CA (US)

(72) Inventor: Stephen Nelson, Woodland Hills, CA (US)

(21) Appl. No.: 16/871,530

(22) Filed: May 11, 2020

(51) Int. Cl. B65D 81/28; B65D 65/40

(52) U.S. Cl. CPC B65D 81/28; B32B 27/06; B65D 65/40

(57) ABSTRACT

An improved wrap that is used in conjunction with beverages, especially those beverages that are placed into beverage holders. These wraps have a dual function of providing an enjoyable experience to the user by wicking away condensation and a protective barrier providing anti-microbial properties. The interior surface of the wrap is coated with materials that facilitate the absorption of moisture and the exterior of the wrap is coated with anti-bacterial agents. Embodiments of this improved wrap include the addition of advertising copy or coupons on the wrap and insulating materials that will keep the beverages hot or cold along with temperature sensitive inks that could warn the user that the beverage is hot or cold. Another embodiment will encompass fragrance that could add to the beverage enjoyment experience, such as wildflowers or lavender with certain teas.

### CROSS REFERENCE TO PENDING APPLICATIONS

This application is not cross-referenced to any pending applications. This invention does not involve any governmental interest and this invention is not made under any federally sponsored research and development grants.

### BACKGROUND OF THE INVENTION

The purpose of this invention is to provide the consumer with a beverage wrap that has many advantageous properties whereby said properties aid in the enjoyment of said beverage. Currently, beverage containers are becoming an essential part of daily life and holders for said containers are being incorporated in our automobiles and trucks and even baby strollers to ride-on lawnmowers. The common thread between the various holders is that they are placed in convenient locations where the user can enjoy the beverage and replace it in a locale that is in the close proximity to its' use.

Currently, beverage container holders are also a collection bin for dust, dirt and grime and are often subjected to moisture due to sublimation or condensation along with the accompanying spillage of the beverage container's contents. Repeated use of said holders only compound the collection of these dirty and potentially harmful residues. Associated very closely with this residue is the presence of harmful bacteria along with pollens and allergens freely floating in the air. Members of the genus Aspergillus were the most common molds identified in automobile beverage holders along with MRSA. Studies show bacteria grow more quickly from spilled food in beverage holders than other places in cars due to the heat associated with the beverage and the location of the beverage holder usually placed in a location closest to the hottest regions of the transmission and exhaust systems. Associated therewith, by their design that facilitates an increased vertical walls to decrease the chance of dislodgement, the beverage holders are deep and usually placed in locations where cleaning is rarely attempted nor accomplished.

This invention is to facilitate the consumer of beverages held in such beverage holders to have a product that will reduce the unfavorable qualities of residue left in such beverage holders and increase the enjoyment of the beverages in a clean dry environment. This invention is to further the concept of cleanliness of the beverage holder by introducing agents that will reduce bacterial growth in the beverage holders and reduce the chance that the beverages will produce moisture that allows for the growth of bacteria in the beverage holders. This being very critical when the beverages are baby bottles and the beverage holders are baby strollers and car seats. Studies have found that beverage holding platforms in baby strollers are rift with rhinovirus, the virus responsible for the common cold.

### SUMMARY OF THE PRIOR ART AND STATE OF THE ART

Currently, people use a variety of paper products including paper napkins, paper dollies, muffin cup liners and plastic sandwich bag to create a situation where excess moisture and debris are wicked away from the beverage container. This creates as many problems if not more than using nothing at all. Paper breaks down in the presence of moisture and creates a bacterial breeding ground as the bacterial is attracted to and feeds upon the decomposition of paper. Furthermore, there are no anti-bacterial compounds present to attempt to deter bacterial growth and nothing is present to prevent the spread of viruses and allergens. Additionally, the current state of the art of anti-septic wipes used on grocery store shopping carts are dubious in their nature of cleansing and their compositions are rarely sufficient to effective kill bacteria and viruses on surfaces. Even if the surface is properly cleaned, the user with then put a bacterially-laden beverage container into the clean shopping cart, thereby eliminating all of the good that was created by the initial cleaning.

As detailed, this current method is fraught with potentially dangerous problems as a safe and anti-septic environment can not be obtained or maintained. Particularly in todays toxic world, obtaining, and most importantly, maintaining, a clean environment is very difficult and potentially deadly.

The sheets disclosed in this disclosure consists of series of layers of fabricated materials that contain anti-bacterial and anti-viral compounds that create and maintain a clean environment, these materials can be formed to a variety of locations and beverage holders so that one can use this sheet in many everyday locations.

This invention is an improvement on what currently exists because the sheets disclosed enable the user to have a clean environment around the beverage container, as well as in the place where the beverage container is sat and potentially the actual user is also cleaned at the same time. Nothing exists as one product with all of the advantages and minimal disadvantages in today's society.

### BRIEF SUMMARY OF THE INVENTION

Accordingly, it is the goal of this invention to create a product that is designed specifically to encompass the exterior portion of a beverage container while providing distinctive properties that will benefit the user. The goal is to create a disposable product which will also contain hygienic properties and wicking properties where the user can be safe from condensation, spillage and thermal contact emanating from the beverage container.

It is another object of this invention to create a product that contains all of the goals of this product and also introducing a marketing platform where the provider of the beverage is able to market his beverage or where other companies can display marketing materials.

It is another object of this invention to create a sanitary layer which will enable children to have a relatively safe environment surrounding their beverage. It is well known that beverage holders, especially those found in automobiles, are cesspools of bacteria and viruses and providing a barrier and possible disinfecting means is another goal of this product. An embodiment creates a clean exterior environment that also includes the users hands as they grasp the beverage container as the external layer of the sheet sanitizes the environment and the users hands at once.

It is an embodiment of this invention to create a sanitizing layer of protection, whereby the beverage container will be surrounded by materials that are able to sanitize the exterior of the beverage container, thereby eliminating bacteria and viruses present on the outside of the beverage container.

### BRIEF DESCRIPTION OF THE DRAWINGS

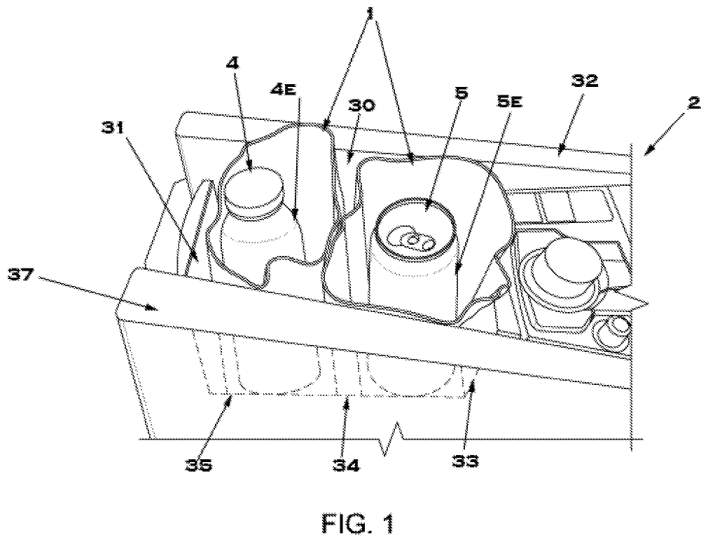

In FIG. 1, shows the invention in use in a typical car environment.

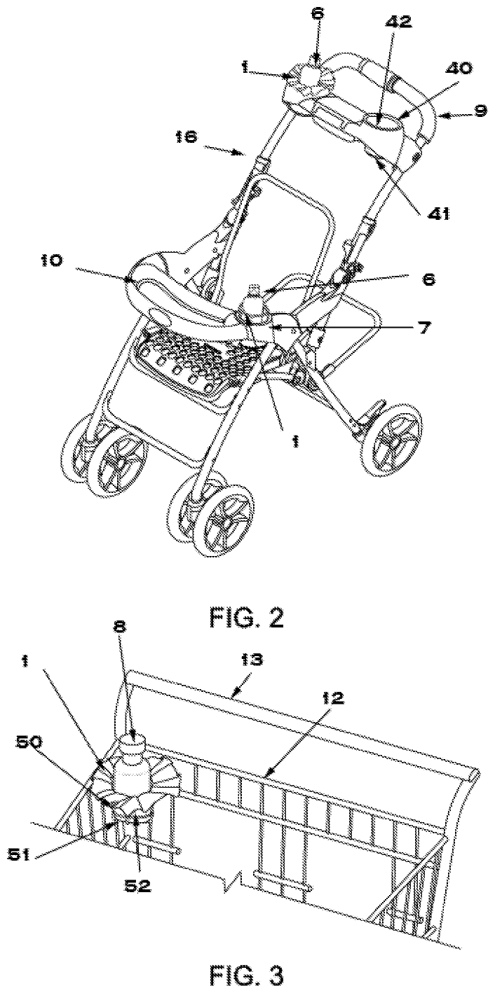

In FIG. 2, shows the invention in use in a baby stroller type of carrier.

In FIG. 3, shows the invention in use in a shopping cart type of environment.

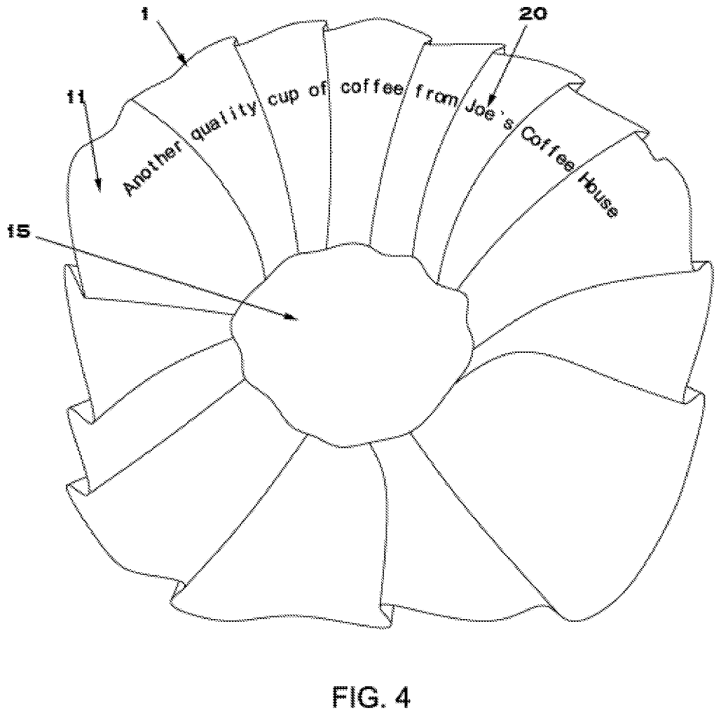

In FIG. 4, shows an embodiment of the invention where marketing materials are included on the interior of the invention.

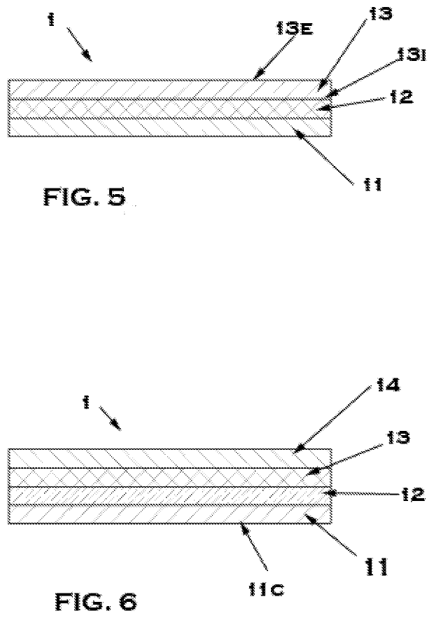

In FIG. 5, a cross-section of the invention is shown showing the basic 3 layers of the invention.

In FIG. 6, a cross-sectional view of an embodiment of the invention is shown showing 4 unique layers.

### DETAILED DESCRIPTION OF THE INVENTION

This invention as disclosed in the drawings has the principle use in locations and devices where beverage containers, such as coffee cups, baby bottles and soft drinks are used. The field of application are those locations where beverage containers are stored for a temporary amount of time and where the beverage container is subject to being a carrier of harmful bacteria, allergens, viruses and germs, purely due to the presence of multiple human contacts, contaminated surfaces and contaminated ambient air.

FIG. 1 details the invention as used in a vehicle where the driver and passenger share a console 2 capable of receiving for storage and access, beverage containers such as bottle 4 and can 5. With larger vehicles, there are often two or more of these consoles and the ones that are located nearby seats commonly occupied by children are usually vestibules of filth, food and a petri dish for bacteria and viruses. Such as in the console 2 shown, beverage containers 4 and 5 are shown each surrounded by an individual enhanced antiseptic wicking contour-conforming beverage container wrap sheet 1. Sheets 1 are previously placed into the beverage holders prior to the insertion of the beverage containers themselves. Console 2 is capable of being in a configuration shown in FIG. 1 as a “2 cup holder” 30 being defined by a lower horizontal surface 35 which are designed to support the weight of the beverage containers 4 and 5 along with defining their vertical limitation of recess into the console 2. Lower horizontal surface 35 has perpendicular to it, walls, emanating in a vertical manner from the surface 35. Surface 35 is shown as hidden lines as it is located in the interior portion of console 2. In this example in FIG. 1, the vertical walls have two corresponding sets of walls, where left wall 32 and right wall 37 are mostly parallel, sometimes diverging slightly to accommodate larger beverage containers in the rearmost opening, where walls 32 and 37 define the lateral spacing defining the depth of the console 2 and where rear wall 31 and forward wall 33 are perpendicular to walls 32 and 37 and form the rearmost location and the forwardmost location of the beverage containers. As this example in FIG. 1 has two separate locations for beverage containers, intermediate wall 34 is located perpendicular to walls 32 and 37 and is located inside of the area defined between walls 31 and 33. Sheet 1 has been placed into the recess defined by said walls and said surface prior to the insertion of said containers. The natural wicking capabilities of said sheet 1 causes the sheet to envelope about the exterior 4e and 5e of said containers 4 and 5 respectively. In an embodiment of the invention, anti-bacterial layer 12 is capable of releasing anti-bacterial agents or trapping bacteria, either approach sterilizing the environment about said containers.

FIG. 5 shows the principle method of practicing the best mode of this invention detailing an exterior layer 13 of said sheet 1 with an central layer with anti-bacterial properties 12 and interior layer 11. Interior layer 11 having an contact layer 11c being in contact with said beverage container. Said exterior layer 13 has an outer side 13e which is not porous so that the user does not have moisture in their hand and also prevents moisture from being displaced into the beverage holder as well. Said exterior layer 13 has an inner layer 13i which is conjoined with central layer 12. It is desired that said interior layer 11 be “moisture-wicking”, porous layer capable of multiple wet and dry cycles while being significantly porous to allow for the effectiveness of said anti-bacterial components of layer 12 to be released onto the contact layer 11c of said interior layer 11 and furthermore said exterior layer 13 should be non-porous and a leak-resistant layer, preferably a polymer based layer to provide protection from wetness contacting the user of the beverage container. Moisture wicking materials are modern technical fabrics which draw moisture away from the beverage container, said fabrics being made of high-tech polyester, which, unlike cotton, absorbs very little water. Cotton will absorb 7% of its weight in water, polyester only 0.4%. Wicking polyester has a special cross-section and a large surface area, which picks up moisture and carries it away from the beverage container, spreading it out, to evaporate easily on the exterior of the fabric. There are two types of anti-bacterial layers that are contemplated in this invention. The principle manner has a layer of bactericidal assemblies which incorporate various biocides including heavy metals (including copper and its alloys (brasses, bronzes, cupronickel, copper-nickel-zinc, and others) which are natural antimicrobial materials), antibiotics, cationic molecules, antimicrobial peptides and enzymes are able to kill surrounding or contacted bacteria. An embodiment would have an anti-bacterial layer 12 of bacterial assemblies which would trap or envelope the bacteria called a bacterial adhesion layer that have been fabricated to adjust the surface properties of the beverage containers such as adjust the surface tension of the beverage container to affect the adhesion of the bacteria to the beverage container's surface through free energy (or wettability), roughness, and surface charge. Said layers of said sheet 1 are conjoined to either through heating or lamination.

FIG. 6 show another embodiment of the invention is where absorbent and porous interior layer 11 is laminated or conjoined with an anti-bacterial layer 12 which is then conjoined to a non-porous exterior layer 13 which prevents moisture due to condensation from touching the hands of the user. This embodiment is unique whereby an additional external anti-bacterial layer 14 is conjoined to the exterior of layer 13 whereby the user will be in contact with the anti-bacterial layer thereby sanitizing the user's hand as well. This is also advantageous when the beverage container with said sheet enveloping said beverage container is placed into a cup holder, such as the one located in console 2, which would likely contain many different bacteria, viruses and germs. This would be especially advantageous whereby young children are drinking and spilling their beverages throughout the car and also would provide anti-bacterial protection to young children's hands as they grasp the beverage container.

FIG. 2 shows another use of sheet 1 in relation to a baby type stroller 10, where baby bottle 6 is located within a bottle holder 40, as sheet 1 envelops the bottle 6 exterior surfaces. Bottle holder 40 is defined by a cylindrical body 42 having a lower bottle stop 41 perpendicular to the axis of body 42. Stroller 10 can have multiple locations where holders are present, such as along the upper handle portion 9 as well as on a removable tray 10 which also serves as a feeding tray, as bottle 6 is located in another cylindrical holder 7 where sheet 1 has already been located interiorly within said holder 7.

FIG. 3 shows a similar concept where a beverage container holder is located on a common shopping cart. Here the example shows a beverage container 8 that is cylindrical in fashion being placed into a cylindrical holder 50. It is common that many retail food establishments are dispensing hygienic wipes for consumers to clean the handle 13 on shopping carts. Unfortunately, retailers have failed to recognize that bacteria, germs and viruses are present wherever people touch, including the beverage holder. Here in this instance, an open basket style cylindrical bottle holder 50 is located near handle 12 usually on the interior side of the shopping cart frame 12. Holder 50 has a lower horizontal cage element 51 which is held in place with vertical cage elements 52 perpendicular to element 51, elements 51 and 52 defining a cylindrical holder body into which sheet 1 is placed prior to the insertion of bottle 8 into said holder 50.

An embodiment of this invention is shown on FIG. 4 where marketing or promotional verbiage 20 can be placed along the interior side 11 of sheet 1. Graphically printed marketing or branding concepts such as particular colors, logos, slogans, marketing or promotional coupons and beverage types can be applied to said interior side 11. This invention is not limited to graphically printed concepts on the interior layer 11 and can be located on the exterior layer as well or instead of. Another embodied concept noted is the inclusion of temperature sensitive inks that would indicate that the beverage container is either hot or cold. Nothing in this invention precludes the use of said marketing or promotional verbiage along said exterior layer 13 of said sheet. Another embodiment would also include fragrance infused into said interior layer 11 or infused upon exterior layer 13, where said fragrance could be heat activated or simply impregnated into the outer side of layer 13. This fragrance could be related to the beverage and designed to enhance the flavors of the beverage, such as herbal scented for teas or essential oils such as peppermint designed to calm and relax the user. FIG. 4 also highlights another embodiment of the invention. Pre-described bottom 15 shaped to contoured to the bottom of a nearly cylindrical beverage container can be pressed into the center of said sheet 1, which will enable the users to more simply place sheet 1 into the recesses of a console such as the one shown in FIG. 1. Sheet 1 can be disclosed as a flat sheet as shown in FIG. 1 or can be pleated as shown in FIGS. 2, 3 and 4. It is an object of this invention to create a product line of products where various layers can be combined suitable for the environment in which it is used. Each layer disclosed herein has a specific purpose, but the disclosure is not limited to only those properties as disclosed herein. This disclosure was developed with non-toxic man-made chemically based cleaning and disinfecting products. The inventor foresees other anti-virial and anti-bacterial materials being used along with the use of essential oils their natural anti-bacterial properties being impregnated into the layers, especially those which are not harmful to the children whose beverage containers are a focused user group.

The composition of the layers used on this invention are preferably bio-degradable polymeric materials, especially those using recycled polymers combined with naturally occurring compounds such as wood pulp, corn based products, and other naturally biodegradable materials that are as self-sustaining as possible.

It can be appreciated by those appropriately skilled in the art that changes, modifications or embodiments can be made to this invention without departing from the spirit, principles, theories, ideas or conceptions that have been disclosed in the foregoing. It is herein recognized that the embodiments disclosed by this description of the best mode of practicing this invention, which will be hereafter described in their full breadth in the claims and equivalents thereof.

What is claimed is:

1. An enhanced antiseptic wicking contour-conforming beverage container wrap sheet for beverage containers comprising:
an interior layer, where said interior layer comprising of material capable of withdrawing moisture away from said beverage container, said interior layer having a contact layer that is to be in contact with said beverage container, and a middle layer conjoined to said interior layer, where said middle layer contains anti-bacterial amalgams, and an exterior layer conjoined to said interior layer and said interior layer, where said exterior layer has a non-porous outer side and a porous inner layer.

2. An enhanced antiseptic wicking contour-conforming beverage container wrap sheet of claim 1 where said anti-bacterial amalgams are impregnated into said middle layer in such a manner as to allow for their release through said interior layer onto said beverage container.

3. An enhanced antiseptic wicking contour-conforming beverage container wrap sheet of claim 2 where said anti-bacterial amalgams contain 1 or more compounds designed to eliminate viruses, harmful bacteria or allergens.

4. An enhanced antiseptic wicking contour-conforming beverage container wrap sheet of claim 3 where said anti-bacterial amalgams are made from essential oils.

5. An enhanced antiseptic wicking contour-conforming beverage container wrap sheet of claim 3 where said anti-bacterial amalgams are made from naturally occurring biocides, cationic molecules, antimicrobial peptides and enzymes.

6. An enhanced antiseptic wicking contour-conforming beverage container wrap sheet of claim 3 where said anti-bacterial amalgams are made from non-toxic man-made chemically based anti-bacterial products.

7. An enhanced antiseptic wicking contour-conforming beverage container wrap sheet of claim 1 where wrap sheet is a flat sheet.

8. An enhanced antiseptic wicking contour-conforming beverage container wrap sheet of claim 1 where said sheet is pleated with a pre-described centrally located flat nonpleated bottom area, said non-pleated area being circular in nature, adapted to the bottom of said beverage container.

9. An enhanced antiseptic wicking contour-conforming beverage container wrap sheet of claim 1 where said sheet is adapted to receive graphically printed images and text.

10. An enhanced antiseptic wicking contour-conforming beverage container wrap sheet of claim 1 where said sheet is impregnated with fragrance.

11. An enhanced antiseptic wicking contour-conforming beverage container wrap sheet for beverage containers comprising:
an interior layer, where said interior layer comprising of material capable of withdrawing moisture away from said beverage container, said interior layer having a contact layer that is to be in contact with said beverage container, and a middle layer conjoined to said interior layer, where said middle layer contains anti-bacterial amalgams, and
an exterior layer conjoined to said interior layer and said interior layer, where said exterior layer has a non-porous outer side and a porous inner layer, and an external anti-bacterial layer conjoined to said exterior layer.

12. An enhanced antiseptic wicking contour-conforming beverage container wrap sheet of claim 11 where said anti-bacterial amalgams are impregnated into said middle layer and said external anti-bacterial layer in such a manner as to allow for their release through said interior layer onto said beverage container and from said external anti-bacterial layer onto the users hands.

13. An enhanced antiseptic wicking contour-conforming beverage container wrap sheet of claim 12 where said anti-bacterial amalgams contain 1 or more compounds designed to eliminate viruses, harmful bacteria or allergens.

14. An enhanced antiseptic wicking contour-conforming beverage container wrap sheet of claim 13 where said anti-bacterial amalgams are made from essential oils.

15. An enhanced antiseptic wicking contour-conforming beverage container wrap sheet of claim 13 where said anti-bacterial amalgams are made from naturally occurring biocides, cationic molecules, antimicrobial peptides and enzymes.

16. An enhanced antiseptic wicking contour-conforming beverage container wrap sheet of claim 13 where said anti-bacterial amalgams are made from non-toxic man-made chemically based anti-bacterial products.

17. An enhanced antiseptic wicking contour-conforming beverage container wrap sheet of claim 11 where wrap sheet is a flat sheet.

18. An enhanced antiseptic wicking contour-conforming beverage container wrap sheet of claim 11 where said sheet is pleated with a pre-described centrally located flat nonpleated bottom area, said non-pleated area being circular in nature, adapted to the bottom of said beverage container.

19. An enhanced antiseptic wicking contour-conforming beverage container wrap sheet of claim 11 where said sheet is adapted to receive graphically printed images and text.

20. An enhanced antiseptic wicking contour-conforming beverage container wrap sheet of claim 11 where said sheet is impregnated with fragrance.
